(19) United States
(12) Patent Application Publication
(10) Pub. No.: US 2015/0041689 A1
(43) Pub. Date: Feb. 12, 2015

(54) Fluid-Actuated Butterfly Valve

(71) Applicant: Woodward, Inc., Fort Collins, CO (US)

(72) Inventor: Robert Piotr Rucinski, Fort Collins, CO (US)

(73) Assignee: Woodward, Inc., Fort Collins, CO (US)

(21) Appl. No.: 13/961,109

(22) Filed: Aug. 7, 2013

(51) Int. Cl. F16K 31/12; F16K 1/226

(52) U.S. Cl. CPC F16K 31/12; F16K 1/226
USPC 251/59

(57) ABSTRACT

The subject matter of this specification can be embodied in, among other things, a valve assembly that includes a valve body having a fluid inlet, fluid outlet, and a movable closure member adapted to block fluid flow from the inlet to the outlet through a housing. The housing has an opening adapted to receive an actuator assembly that includes a central stationary shaft having at least one stator vane. A rotating collar is disposed around the stator vane and a portion of the central stationary shaft. The rotating collar has a housing and at least one stop member disposed inwardly in a cavity of the rotating collar. The rotating collar has at least two actuation chambers defined by the inner wall of the cavity in the rotating collar, the stationary vane, and the stop member. The rotating collar is coupled to the movable valve closure member.

### TECHNICAL FIELD

This invention relates to a valve device and more particularly to a butterfly type valve that is actuated by a vane type actuator device moved by fluid under pressure.

### BACKGROUND

To maximize the efficiency turbine engines are being run close to extreme conditions. To prevent compressor stall or provide blade clearance control, a series of air valves are sometimes used. These valve assemblies generally consist of an actuator and valve, often as a single line replacement unit (LRU). Coupling between the actuator and the valve, however, can require a tradeoff between the sometimes conflicting requirements of efficient torque transfer, size, weight, manufacturing complexity, and tolerance of misalignments in the valve assemblies.

Rotary hydraulic actuators of various forms are currently used in industrial mechanical power conversion applications. This industrial usage is common for applications where continuous inertial loading is desired without the need for load holding for long durations, e.g. hours, without the use of an external fluid power supply. Aircraft flight control applications generally implement loaded positional holding, for example, in a failure mitigation mode, using substantially only the blocked fluid column to hold position.

### SUMMARY

In general, this document describes a fluid-actuated butterfly valve.

In a first aspect, a valve assembly includes a valve body including a fluid inlet and fluid outlet and movable closure member disposed in a housing, said closure member adapted to substantially block fluid flow from the inlet to the outlet; said housing further having an opening adapted to receive an actuator assembly. The actuator assembly includes a central stationary shaft disposed in the valve body, said shaft having at least one stator vane member affixed to the central stationary shaft. A rotating collar assembly is disposed around the stator vane member and a portion of the central stationary shaft. The rotating collar assembly has a housing adapted to be received in the valve body, and has at least one stop member disposed inwardly in an inner cavity of the rotating collar assembly. The stop member is adapted to contact the stator vane member when the rotary collar assembly is rotated around the central shaft assembly in a first direction and adapted to contact the vane member when the rotary collar assembly is rotated in the opposite direction. The rotating collar has at least two actuation chambers defined by a portion of the inner wall of the cavity in the rotating collar assembly, the stationary vane member, and the stop member. The rotating collar assembly is coupled to the movable valve closure member.

Various embodiments can include some, all, or none of the following features. The movable closure member can be a butterfly closure disc configured to open to allow fluid flow from the valve inlet to the valve outlet and close to substantially block fluid flow from the inlet to the outlet. The valve assembly can include an inlet actuation fluid port and an outlet actuation fluid port, each of said fluid ports fluidly connected to each actuation chamber in the rotating chamber assembly. The valve assembly can include a vane seal disposed on the stationary vane member, said vane seal adapted to sealingly engage a portion of the inner wall of the cavity. The valve assembly can include a stop seal disposed on the rotating collar assembly, said stop seal adapted to sealingly engage a portion of the central stationary shaft. The valve assembly can include a position sensor adapted to provide information indicative of the rotational position of the movable valve closure member relative to the central stationary shaft. The central stationary shaft can have at least a pair of the stator vane members, and the rotating collar assembly can have at least two stop members.

In a second aspect, a method for controlling fluid flow includes providing a flow body including a fluid inlet and fluid outlet, providing a central stationary shaft disposed in the flow body, said shaft having at least one stator vane member affixed to the central stationary shaft, providing a rotating collar assembly disposed around the stator vane member and a portion of the central stationary shaft. The rotating collar assembly has at least one stop member disposed inwardly in an inner cavity of the rotor ring assembly and includes a first side and a second side and adapted to contact the stator vane member when the rotor ring assembly is rotated around the central shaft assembly in a first direction and adapted to contact the stator vane member when the rotor ring assembly is rotated in the opposite direction. The rotor ring includes at least two actuation chambers defined by a portion of the inner wall of the cavity in the rotor ring assembly, the stationary vane member, and the stop member. The method also includes providing a rotor housing disposed in the flow body, said rotor housing adapted to substantially block fluid flow from the inlet to the outlet, wherein said rotor ring assembly is coupled to the rotor housing, providing a rotational fluid at a first pressure and contacting the first side of the stop member of the rotor ring assembly with the first rotational fluid, providing a rotational fluid at a second pressure less than the first pressure and contacting the second side of the stop member of the rotor ring assembly with the second rotational fluid, and rotating the rotor housing in a first direction of rotation.

Various implementations can include some, all, or none of the following features. The method can also include increasing the second pressure and reducing the first pressure until the second pressure is greater than the first pressure, and rotating the rotor housing in an opposite direction to the first direction of rotation. The method can also include stopping the rotation of the rotor housing in the opposite direction by contacting the stop member with the stator vane member. Providing the central stationary shaft can include providing at least a pair of the stator vane members, and providing the rotating collar assembly includes providing at least two stop members. The central stationary shaft, the rotor ring, and the rotor housing can isolate the rotational fluid into a first opposing pair of chambers and a second opposing pair of chambers, and the method can also include providing the first rotational fluid at the first pressure to the first opposing pair of chambers, and providing the second rotational fluid at the second pressure to the second opposing pair of chambers. The first end of the stationary vane member can also include a first fluid port formed therethrough and the second end includes a second fluid port formed therethrough, and wherein providing the rotational fluid at a first pressure is provided through the first fluid port and providing the rotational fluid at a second pressure is provided through the second fluid port.

The systems and techniques described here may provide one or more of the following advantages. First, a system can provide a butterfly valve with a relatively smaller packaging envelope and/or less weight than other butterfly valves of similar capacity. Second, the described butterfly valve can be provided with a reduced number of component parts compared to other butterfly valves of similar capacity. Third, the described butterfly valve can provide increased control position precision. Fourth, the described butterfly valve can provide relatively stiffer direct hydraulic actuation coupling. Fifth, the described butterfly valve can provide increased unit vibratory resistance.

The details of one or more implementations are set forth in the accompanying drawings and the description below. Other features and advantages will be apparent from the description and drawings, and from the claims.

### DESCRIPTION OF DRAWINGS

FIG. 1A is a perspective view of an example fluid-actuated butterfly valve assembly.

FIG. 1B is a cutaway partial perspective view of the example fluid-actuated butterfly valve assembly of FIG. 1A.

FIG. 2A is a cross-sectional side view of the example fluid-actuated butterfly valve assembly of FIG. 1A.

FIG. 2B is a cutaway perspective view of the example fluid-actuated butterfly valve assembly of FIG. 1A.

FIG. 3A is a top view of opposing stationary vane members (stator vanes) and a rotating collar assembly (rotor ring) in an actuator portion of the example fluid-actuated butterfly valve assembly of FIG. 1A.

FIG. 3B is a cutaway perspective view of the opposing stationary vane member and a rotating collar assembly of the actuator portion of the example fluid-actuated butterfly valve assembly of FIG. 3A.

FIG. 3C is a perspective view of the stationary vane member of FIG. 3A.

FIG. 3D is a perspective view of the actuator portion of FIG. 3B.

FIG. 4A is a perspective view of a closure disc and actuator portion components of an example fluid-actuated butterfly valve actuator of FIG. 1A.

FIG. 4B is a cutaway perspective view of the example fluid-actuated butterfly valve actuator of FIG. 4A.

FIGS. 4C-4E are cross-sectional side views of the example fluid-actuated butterfly valve actuator of FIG. 4A in three different rotational orientations.

FIG. 5 is a perspective view of an example position sensor assembly in the example butterfly valve of FIG. 1A.

FIG. 6 is a flow chart illustrating operational steps for the fluid actuated butterfly valve of FIGS. 1A to 5.

### DETAILED DESCRIPTION

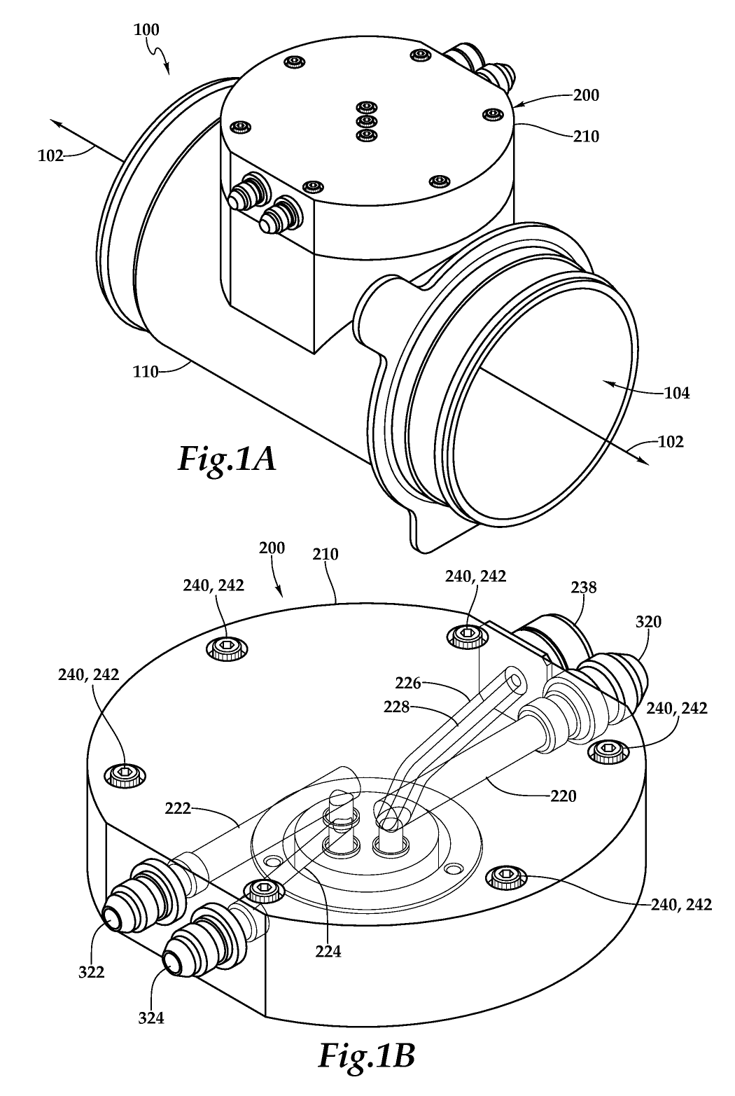

FIG. 1A is a perspective view of an example fluid-actuated butterfly valve assembly 100. In general, the fluid-actuated butterfly valve assembly 100 is a butterfly valve in which the butterfly plate is integral with a rotating housing of a fluid-actuated vane actuator extending into a flow path 102 of the fluid to be controlled. The assembly 100 includes a flow body 110 and a fluid-actuated butterfly valve actuator assembly 200 that will be discussed further in the descriptions of FIGS. 1B-5. The flow path 102 passes through a central bore 104 of the flow body 110.

The fluid-actuated butterfly valve actuator assembly 200 includes a top cap assembly 210. FIG. 1B is a cutaway perspective view of the top cap assembly 210. The top cap assembly 210 includes a fluid conduit 220, a fluid conduit 222, and a drain conduit 224. The fluid conduit 220 is fluidically coupled to a fluid fitting 320, the fluid conduit 222 is fluidically coupled to a fluid fitting 322, and the drain conduit 224 is fluidically coupled to a fluid fitting 324.

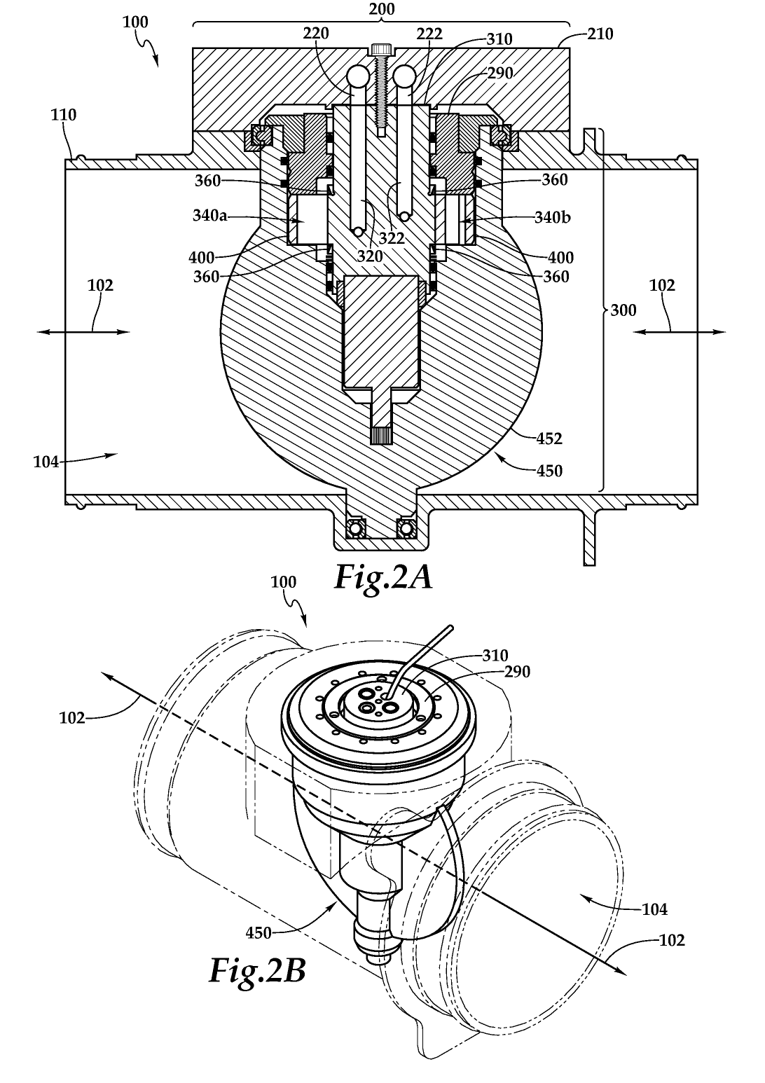

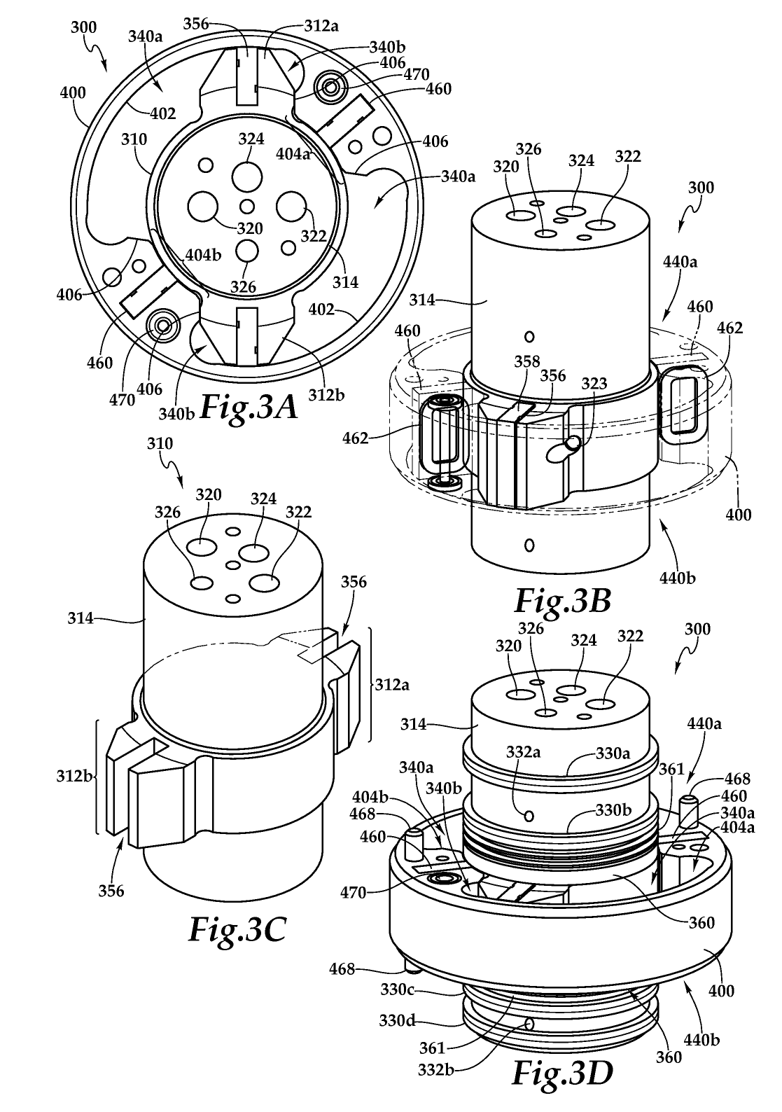

The fluid conduits 220-222 are fluidically coupled to fluid chambers within the fluid-actuated butterfly valve actuator assembly 200. Pressurized fluid (e.g., control fluid) can be controllably applied to the fluid conduits 220-222 to actuate the fluid-actuated butterfly valve assembly 100 to move a closure member in the fluid actuated valve assembly 100 to control the flow of a controlled fluid through the flow body 110. In some implementations, the pressurized fluid can be a liquid (e.g., oil, hydraulic fluid, water) or a gas (e.g., air, nitrogen, CO2). The drain conduit 224 is fluidically coupled to drain cavities within the assembly 200. Excess fluid, e.g., leakage fluid, collected within the drain cavities flows out the drain conduit 224. The fluid chambers and drain cavities are discussed further in the descriptions of FIGS. 2A, 3A, and 3B.

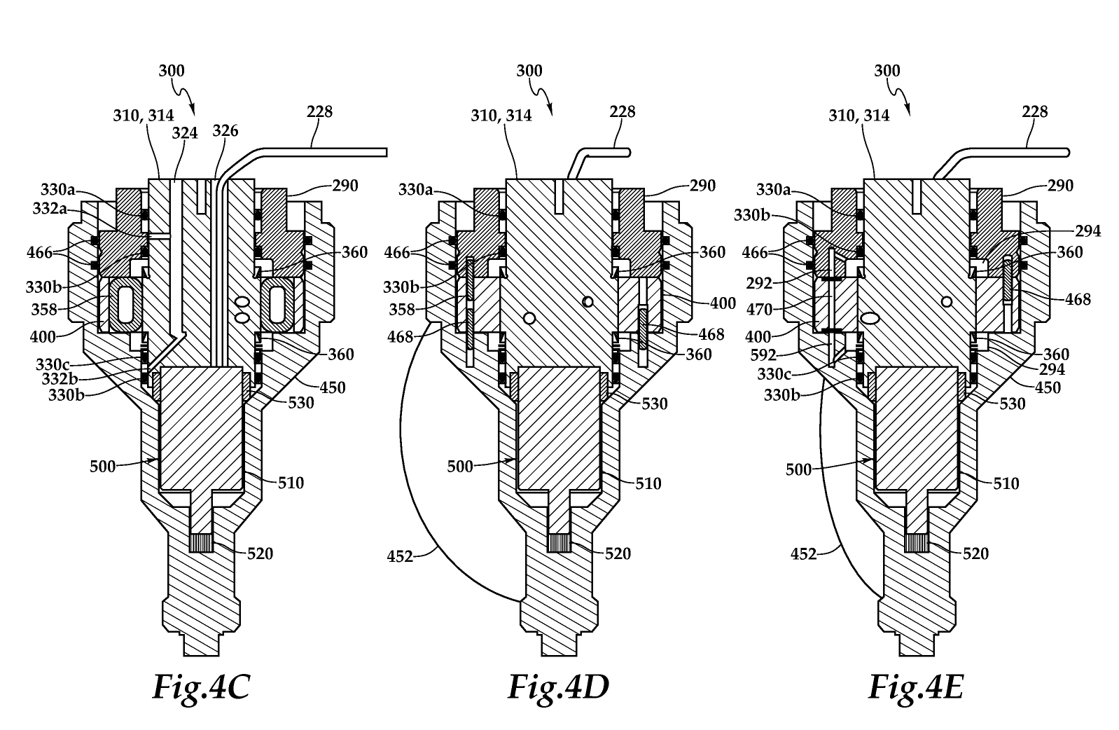

An electrical conduit 226 accommodates an electrical cable 228. The electrical cable 228 conducts one or more electrical signals between an electrical connector 238 and a position sensor or encoder (not shown). The position encoder is discussed further in the descriptions of FIGS. 2A and 5. A collection of fastener bores 240 are provided to accommodate a collection of fasteners 242 (e.g., bolts, screws) to secure the top cap assembly 210 to the fluid-actuated butterfly valve assembly 200.

FIG. 2A is a cross-sectional side view of the example fluid-actuated butterfly valve assembly 100. Visible in this view are the flow body 110, the fluid-actuated butterfly valve actuator assembly 200, and the top cap assembly 210. The top cap assembly 210 is shown with one of the fasteners 242 passed through the fastener bore 240 to removably affix the top cap assembly 210 to a stationary shaft 310 of a fluid-actuated butterfly valve actuator 300. The actuator 300 extends into the central bore 104 and the flow path 102 of the fluid to be controlled. The fluid conduit 220 aligns with and fluidically connects to a fluid conduit 320 formed in the stationary shaft 310. The fluid conduit 222 aligns with and fluidically connects to a fluid conduit 322 also formed in the stationary shaft 310.

Referring now to FIGS. 3A-3D, the example fluid-actuated butterfly valve actuator 300 will be discussed. FIG. 3A is a top view of the example fluid-actuated butterfly valve actuator 300, FIG. 3B is a cutaway perspective view of the example fluid-actuated butterfly valve actuator 300, and FIG. 3C is a perspective view of the example fluid-actuated butterfly valve actuator 300. The assembly includes the stationary shaft 310 and a rotor ring 400.

In general terms, the fluid-actuated butterfly valve actuator 300 is similar to a rotary vane actuator (RVA). Most RVAs used implement a stationary housing with stator members and with a rotatable central shaft with attached vane members wherein the vane members affixed to the rotating shaft can be urged to rotate (e.g., rotary vane members) through the application of pressurized fluids to the rotary vane members provided through conduits formed in the stationary housing. However, in the example of the fluid-actuated butterfly valve actuator 300 of the present disclosure, the stationary shaft 310 is held substantially stationary (e.g., relative to the flow body 110), while fluid pressure applied through the fluid conduits 320-322 is used to urge bidirectional rotation of the rotor ring (a/k/a rotating collar assembly) 400 about the stationary shaft 310.

The rotor ring 400 includes a cylindrical bore 402. The cylindrical bore 402 is a chamber that encloses stationary shaft 310. The stationary shaft 310 is a machined cylindrical component consisting of a first stator vane 312a, a second stator vane 312b and a centered cylindrical hub 314. In some embodiments, the diameter and linear dimensions of the first and second stator vanes 312a, 312b are equivalent to the diameter and depth of the cylindrical bore 402.

The rotor ring is able to rotate about 90 degrees in both a clockwise and counterclockwise direction relative to the stationary shaft 310. Within the cylindrical bore 402, the rotor ring 400 includes a first member 404a and a second member 404b. The stator vanes 312a and 312b act as stops for the rotor ring 400 and prevent further rotational movement of the rotor ring 400. A collection of outside lateral surfaces 406 of the members 404a and 404b provide the stops for the rotor ring 400.

The first and second stator vanes 312a and 312b include a groove 356. As shown in FIG. 3B, each of the grooves 356 includes one or more seals 358 configured to contact the wall of the cylindrical bore 402. The first and second members 404a and 404b include a groove 460. Each of the grooves 460 includes one or more corner seals 462 configured to contact the stationary shaft 310.

As seen in FIG. 3D, a pair of corner seals 360 are in sealing contact about the outer circumference of the cylindrical hub 314. The corner seals 360 are compliantly urged into sealing contact with an upper longitudinal end 440a and a lower longitudinal end 440b of the rotor ring 400 by a pair of spring energizers 361. The corner seals 360 are also urged into sealing contact with the upper longitudinal end 440a and the lower longitudinal end 440b of the rotor ring 400 by pressurized fluid provided through pair of fluid passages 470 which will be discussed further in the description of FIG. 3E.

Referring once again to FIGS. 3B and 3C, the seals 358 and the corner seals 360 and 462 radially define a pair of pressure chambers 340a positioned radially opposite of each other across the stationary shaft 310, and a pair of opposing pressure chambers 340b positioned radially opposite each other across the stationary shaft 310. In use, fluid is introduced or removed from the pressure chambers 340a and 340b through the fluid conduits 320, 322, and a pair of fluid ports 323 exposed to the pressure chambers 340a, 340b. Rotational fluid at a first pressure can be provided through one or more of the fluid ports 323 and rotational fluid at a second pressure can be provided through another one or more of the fluid ports 323. For example, fluid can be applied at the fluid port 320 and flowed to the chambers 340a through the fluid ports 323. Similarly, fluid can be applied at the fluid port 322 and flowed through the fluid ports 323 to the chambers 340b. In some implementations, the stator vanes 312a, 312b can include the fluid ports 323 formed therethrough.

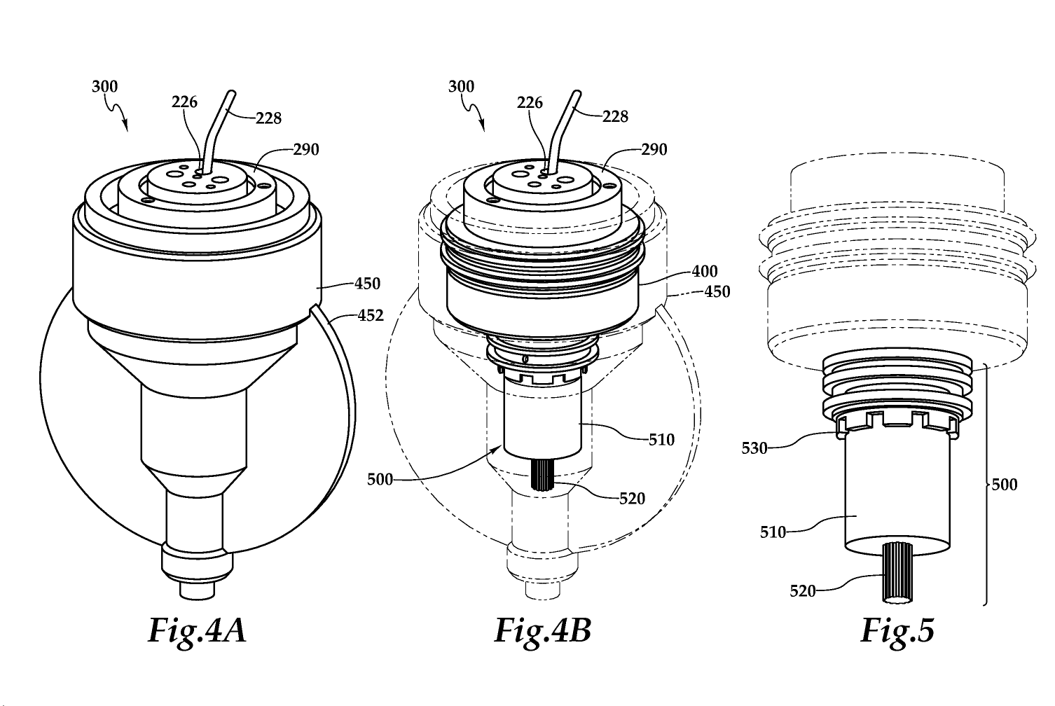

The pressure chambers 340a, 340b are defined longitudinally by a rotor housing 450 and an actuator cap 290 that will be discussed further in the descriptions of FIGS. 2A-2B and 4A-4E below. By creating a fluid pressure differential between the pressure chambers 340a and the pressure chambers 340b, the rotor ring 400 can be urged to rotate clockwise or counterclockwise relative to the stationary shaft 310.

As seen in FIGS. 3D and 4C, a collection of dynamic seals 330a-330d is in sealing contact about the outer circumference of the cylindrical hub 314. The dynamic seals 330b and 330c are positioned along the cylindrical hub 314 longitudinally outward from the corner seals. The dynamic seal 330a is positioned longitudinally further outward from the seal 330b along the cylindrical hub 314 such that a drain port 332a is located between the dynamic seals 330a and the dynamic seal 330b. Similarly, the dynamic seal 330d is positioned longitudinally further outward from the seal 330c along the cylindrical hub 314 such that a drain port 332b is located between the dynamic seals 330c and the dynamic seal 330d.

The drain ports 332a, 332b are in fluidic communication with the drain conduit 324. Fluid leaking longitudinally away from the pressure chambers 340a, 340b and past the dynamic seal 330b will be blocked by the dynamic seal 330a and allowed to flow out the drain port 332a. Similarly, fluid leaking longitudinally away from the pressure chambers 340a, 340b and past the dynamic seal 330c will be blocked by the dynamic seal 330d and allowed to flow out the drain port 332b.

FIG. 4A is a perspective view of a closure member and actuator portion components of the example fluid-actuated butterfly valve actuator 300, and FIG. 4B is a cutaway perspective view of the example fluid-actuated butterfly valve actuator 300. FIGS. 4C-4E are cross-sectional side views of an example fluid-actuated butterfly valve actuator 300 in three different rotational orientations. The rotor housing 450 includes a closure disc 452 that is configured to rotate within the central bore 104 between at least a substantially parallel orientation and a substantially perpendicular orientation relative to the flow path 102. FIG. 4C shows the actuator 300 in a cross-section taken substantially perpendicular (e.g., 90 degrees) to the orientation of the closure disc 452 and the view shown in FIG. 2A. FIGS. 4D and 4E show the actuator 300 in cross-sections taken at approximately 25 degree and approximately 66 degree orientations, respectively.

In the views of FIGS. 4D and-4E, the rotor ring 400 is shown removably connected to the rotor housing 450 and the actuator cap 290 by a collection of locating pins 468, also illustrated in FIG. 3D. The rotor ring 400 is removably secured to the rotor housing 450 longitudinally by the actuator cap 290. A pair of seals 466 is in sealing contact between the outer periphery of the actuator cap 290 and the rotor housing 450. In some implementations, the seals 358, 462, and 330a-330d can be 0-rings, X-rings, Q-rings, D-rings, energized seals, or combinations of these and/or any other appropriate form of seals.

The fluid-actuated butterfly valve actuator 300 includes a position sensor assembly 500. The position sensor includes a housing 510 and an input shaft 520. The position sensor assembly 500 includes electromechanical components that can sense rotation of the input shaft 520 relative to the housing 510, and encode and transmit signals indicative of the rotational position of the input shaft 520 relative to the housing 510. Referring to FIG. 4C, signals provided by the position sensor assembly 500 are transmitted to external devices through the electrical cable 228 that runs through the conduit 226.

The housing 510 is removably coupled to the stationary shaft 310 and remains substantially motionless relative to the stationary shaft 310. The input shaft 520 is removably coupled to the rotor housing 450 via splines on the shaft 520 and mating splines on the housing 450. As the rotor housing 450 is rotated by the rotor ring 400 relative to the stationary shaft 310, the input shaft 520 is proportionally rotated relative to the housing 510 such that the position of the rotor housing 450 and the closure disc 452 relative to the flow path 102 in the flow body 110 can be sensed by the position sensor assembly 500 and provided to other equipment. In some embodiments, position signals provided by the position sensor assembly 500 can be used as feedback in a position control loop to adjust the position of the closure disc 452 and control the volume and rate of flow through the valve 100.

Referring now to FIG. 5, a perspective view of the example position sensor assembly 500 is shown. Visible are the housing 510 and the input shaft 520. Also visible is a spanner nut 530. Referring again to FIGS. 4B-4E, the spanner nut 530 is also visible. During assembly of the fluid-actuated butterfly valve actuator assembly 200, the position sensor 500 is removably affixed to the cylindrical hub 314 by the spanner nut 530. In some embodiments, the position sensor 500 can include tabs that can guide the sensor 500 into a predetermined position. The spanner nut 530 can then be pressed against the tabs and provide mechanical locking of the position sensor 500 to the stationary shaft 310.

Referring again to FIGS. 3A, 3B, 3D, and 4E, the rotor ring 400 includes the pair of fluid passages 470. As best seen in FIG. 4E, the fluid passages 470 are in fluidic communication with a pair of fluid passages 292 within the actuator cap and a pair of fluid passages 592 within the rotor housing 450. The fluid passages 470, 292, and 592 are in fluidic communication with a pair of fluid chambers 294 that are exposed to the corner seals 360. In some implementations, fluid pressure can be provided to the fluid passages 470, 292, and 592 to load the corner seals 360 at the higher of the two fluid pressures present in the fluid chambers 340a, 340b.

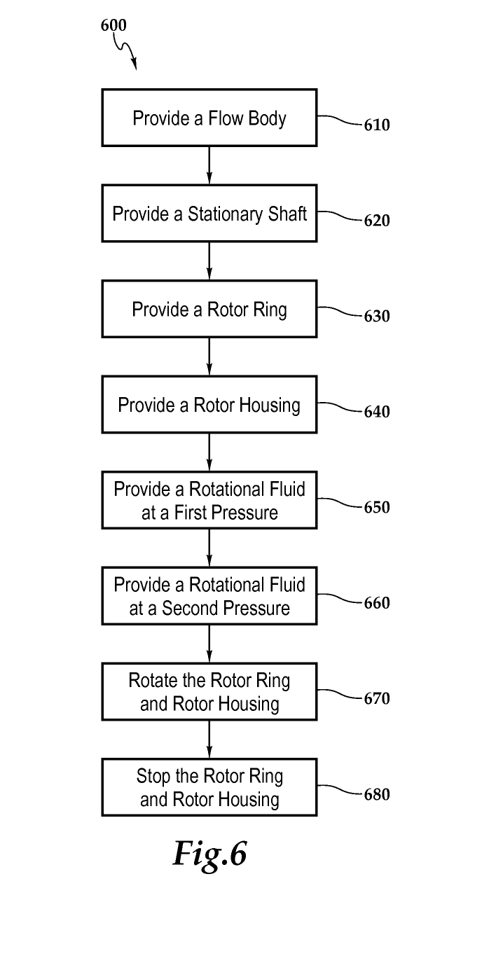

FIG. 6 is a flow diagram of an example process 600 for rotating a fluid-actuated butterfly valve assembly (e.g., the fluid-actuated butterfly valve assembly 100 of FIG. 1A). At step 610, the flow body 110 is provided. At step 620 the stationary shaft 310 is provided. For example, as shown in FIGS. 2A and 2B, the stationary shaft 310 extends into the flow path 102 that passes through the central bore 104 of the flow body 110. The stationary shaft 310 includes the stator vanes 312a and 312b.

At 630, the rotor ring 400 is provided. For example, as shown in FIGS. 2A and 2B, the rotor ring 400 is placed about the stationary shaft 310. The rotor ring 400 includes first member 404a and the second member 404b. In some embodiments, the first member 404a and the second member 404b can be part of the actuator cap 290.

At 640, the rotor housing 450 is provided. For example, as shown in FIGS. 2A and 2B, the rotor housing 450 is placed about the rotor ring 400 and the stationary shaft 310. The rotor housing 450 is removably coupled to the rotor ring 400. In some implementations, the rotor ring 400 may be formed integrally with the rotor housing 450.

At step 650, a rotational fluid is provided at a first pressure and contacting the first vane with the first rotational fluid. For example, hydraulic fluid can be applied through the fluid port 322 to the chambers 340b.

At step 660, a rotational fluid is provided at a second pressure less than the first pressure and contacting the second vane with the second rotational fluid. For example, as the rotor assembly rotates clockwise, fluid in the fluid chambers 340a is displaced and flows out through the fluid port 320.

At step 670, the rotor ring 400 and the rotor housing 450 are rotated in a first direction of rotation. For example, the rotor ring 400 and the rotor housing 450 can start in a position in which the closure disc 452 is substantially parallel to the flow path 102, as illustrated in FIGS. 2A and 2B. As fluids are controllably applied to the fluid chambers 340a, 340b, the disc 452 can be rotated away from the parallel orientation, progressively blocking the flow path 102. Motion of the rotor ring 400 along an approximately 90 degree range of motion urges rotation of the rotor housing 450 between its substantially perpendicular and parallel positions relative to the flow path 102, selectively blocking and permitting fluid flow through the flow body central cavity 104.

Rotation of the rotor ring 400 is transferred to the rotor housing 450. As the rotor ring 400 rotates, the rotor housing 450 is also urged to rotate. The rotor housing 450 includes the disc 452 that is configured to rotate within the central bore 104 between at least a substantially parallel orientation and a substantially perpendicular orientation relative to the flow path 102. The disc 452 is configured with a thickness that substantially allows fluid to flow through the flow body 110 while the disc is substantially parallel to flow path 102, and the disc 452 is configured with a diameter that substantially blocks fluid flow through the flow body 110 while the disc is substantially perpendicular to the flow path 102.

At step 680, the rotation of the rotor ring 400 and the rotor housing 450 is stopped by contacting at least one of the outside lateral surfaces 406 with at least one of the stator vanes 312a, 312b. For example, FIG. 2A illustrates the rotor ring 400 with the members 404a, 404b in contact with the stator vanes 312a, 312b.

In some implementations, the rotor assembly can be rotated in the opposite direction to the first direction of rotation by increasing the second pressure and reducing the first pressure until the second pressure is greater than the first pressure. In some implementations, the rotation of the rotor assembly in the opposite direction can be stopped by contacting opposite sides of at least one of the members 404a, 404b with the stator vanes 312a, 312b.

Although the example fluid-actuated butterfly valve assembly 100 is described as having a pair of the stator vanes 312a-312b and a pair of the members 404a-404b to form opposing pairs of the pressure chambers 340a-340b, other embodiments can exist. In some embodiments, the fluid-actuated butterfly valve assembly 100 can include a single one of the stator vanes 312a or 213b and a single one of the members 404a or 404b. For example, the pressure chambers on each side of a single member connected to the rotor ring 400 may be pressurized and depressurized to rotate the member away from contacting a first side of a single stator, and rotate the member about 270 degrees to contact a second side of the single stator. Rotation in the opposite direction can be accomplished by reversing the pressurization of the pressure chambers.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A valve assembly comprising:
a valve body including a fluid inlet and fluid outlet and movable closure member disposed in a housing, said closure member adapted to substantially block fluid flow from the inlet to the outlet; said housing further having an opening adapted to receive an actuator assembly;
said actuator assembly comprising:
a central stationary shaft disposed in the valve body, said shaft having at least one stator vane member affixed to the central stationary shaft; and
a rotating collar assembly disposed around the stator vane member and a portion of the central stationary shaft, said rotating collar assembly having a housing adapted to be received in the valve body, said rotating collar assembly having at least one stop member disposed inwardly in an inner cavity of the rotating collar assembly, the stop member adapted to contact the stator vane member when the rotary collar assembly is rotated around the central shaft assembly in a first direction and adapted to contact the vane member when the rotary collar assembly is rotated in the opposite direction, said rotating collar having at least two actuation chambers defined by a portion of the inner wall of the cavity in the rotating collar assembly, the stationary vane member, and the stop member;
wherein said rotating collar assembly is coupled to the movable valve closure member.

2. The valve assembly of claim 1, wherein the movable closure member is a butterfly closure disc configured to open to allow fluid flow from the valve inlet to the valve outlet and close to substantially block fluid flow from the inlet to the outlet.

3. The valve assembly of claim 1 further including an inlet actuation fluid port and an outlet actuation fluid port, each of said fluid ports fluidly connected to each actuation chamber in the rotating chamber assembly.

4. The valve assembly of claim 1 further including a vane seal disposed on the stationary vane member, said vane seal adapted to sealingly engage a portion of the inner wall of the cavity.

5. The valve assembly of claim 1 further including a stop seal disposed on the rotating collar assembly, said stop seal adapted to sealingly engage a portion of the central stationary shaft.

6. The valve assembly of claim 1 further including a position sensor adapted to provide information indicative of the rotational position of the movable valve closure member relative to the central stationary shaft.

7. The valve assembly of claim 1, wherein the central stationary shaft has at least a pair of the stator vane members, and the rotating collar assembly has at least two stop members.

8. A method for controlling fluid flow, the method comprising:
providing a flow body including a fluid inlet and fluid outlet;
providing a central stationary shaft disposed in the flow body, said shaft having at least one stator vane member affixed to the central stationary shaft;
providing a rotating collar assembly disposed around the stator vane member and a portion of the central stationary shaft, said rotating collar assembly having at least one stop member disposed inwardly in an inner cavity of the rotor ring assembly, the stop member comprising a first side and a second side and adapted to contact the stator vane member when the rotor ring assembly is rotated around the central shaft assembly in a first direction and adapted to contact the stator vane member when the rotor ring assembly is rotated in the opposite direction, said rotor ring having at least two actuation chambers defined by a portion of the inner wall of the cavity in the rotor ring assembly, the stationary vane member, and the stop member;
providing a rotor housing disposed in the flow body, said rotor housing adapted to substantially block fluid flow from the inlet to the outlet, wherein said rotor ring assembly is coupled to the rotor housing;
providing a rotational fluid at a first pressure and contacting the first side of the stop member of the rotor ring assembly with the first rotational fluid;
providing a rotational fluid at a second pressure less than the first pressure and contacting the second side of the stop member of the rotor ring assembly with the second rotational fluid; and
rotating the rotor housing in a first direction of rotation.

9. The method of claim 8 further including:
increasing the second pressure and reducing the first pressure until the second pressure is greater than the first pressure; and
rotating the rotor housing in an opposite direction to the first direction of rotation.

10. The method of claim 9 further including:
stopping the rotation of the rotor housing in the opposite direction by contacting the stop member with the stator vane member.

11. The method of claim 8, wherein providing the central stationary shaft includes providing at least a pair of the stator vane members, and providing the rotating collar assembly includes providing at least two stop members.

12. The method of claim 11, wherein the central stationary shaft, the rotor ring, and the rotor housing isolates the rotational fluid into a first opposing pair of chambers and a second opposing pair of chambers, and the method further comprises:
providing the first rotational fluid at the first pressure to the first opposing pair of chambers, and
providing the second rotational fluid at the second pressure to the second opposing pair of chambers.

13. The method of claim 8, wherein the first end of the stationary vane member further includes a first fluid port formed therethrough and the second end includes a second fluid port formed therethrough, and wherein providing the rotational fluid at a first pressure is provided through the first fluid port and providing the rotational fluid at a second pressure is provided through the second fluid port.
